(19) United States
(12) Patent Application Publication
(10) Pub. No.: US 2015/0330899 A1
(43) Pub. Date: Nov. 19, 2015

(54) DEVICE, SYSTEM AND METHOD OF MAKING A SENSOR

(71) Applicants: Andreas E. Vasdekis, Richland, WA (US); Jay W. Grate, West Richland, WA (US); Matthew J. O'Hara, Richland, WA (US)

(72) Inventors: Andreas E. Vasdekis, Richland, WA (US); Jay W. Grate, West Richland, WA (US); Matthew J. O'Hara, Richland, WA (US)

(73) Assignee: BATTELLE MEMORIAL INSTITUTE, Richland, WA (US)

(21) Appl. No.: 14/710,907

(22) Filed: May 13, 2015

Related U.S. Application Data
(60) Provisional application No. 61/996,811, filed on May 14, 2014.

(51) Int. Cl. G01N 21/64; B32B 38/00; B32B 37/24; B05D 5/06; B32B 37/18

(52) U.S. Cl. CPC G01N 21/6428; B05D 5/06; B32B 37/18; B32B 37/24; B32B 38/0012; B32B 2037/243

(57) ABSTRACT

A sensor, system, and method of making a sensor are disclosed. The sensor includes a solid polymer material, and a dopant-containing region of discrete thickness at a surface of the solid polymer. The method of creating the sensor includes impregnating the polymer material with the dopant by contact with a solvent solution containing the dopants. A polymer/solvent gel-layer, whose depth increases with impregnation time, forms after contact of the polymer material in the solvent solution. The dopants are diffused into the polymer material, forming a dopant-containing region of discrete thickness at a surface of the solid polymer.

### CROSS-REFERENCE TO RELATED APPLICATIONS

This application claims priority to U.S. Provisional Application Ser. No. 61/996,811, filed May 14, 2014, titled “Surface layers, sensors, and method of making the same by solvent immersion and dopant diffusion,” hereby incorporated by reference in its entirety for all of its teachings.

### STATEMENT REGARDING FEDERALLY SPONSORED RESEARCH OR DEVELOPMENT

This invention was made with Government support under Contract DE-AC0576RLO1830 awarded by the U.S. Department of Energy. The Government has certain rights in the invention.

### TECHNICAL FIELD

This invention relates to sensors. More specifically, this invention relates to a sensor including a doped layer formed after impregnation of a polymer material by a solvent solution containing dopants, wherein the doped layer is responsive to matter or energy.

### BACKGROUND

Many methods exist for fabricating sensors that apply a thin layer onto a surface. Methods exist to cast polymer films containing a dye molecule by preparing a solution containing both the dye and the polymer in a solvent and solvent-casting this mixture.

While simple in principle, these methods prepare a layer that is separate from the bulk supporting material on which the layer is applied. Failures can occur at the interface between the surface layer and the bulk material. The surface layer may dewet from the surface, or may delaminate, craze or otherwise degrade because it is not mechanically strong as a thin surface layer. Solvent casting is also problematic for surfaces that are not large and planar. Solvent cast films become uneven when the surface is irregular and at surface edges.

Solvent Assisted Micromolding (SAMIM) is a solvent-based technique that uses imprinting or stamping to create three dimensional structures in polymer materials such as microchannels. In SAMIM, the solvent coats a Polydimethilsiloxane (PDMS) covered stamp, which is subsequently pressed against a thin polymer film causing it to partially dissolve and conform to the stamp's pattern. Solvent vapors have also been used to the same end, dissolving the polymer by first propagating through the pores of the PDMS stamp. Solvent-assisted nano-imprinting methods such as these are used for solvent based microfluidic prototyping. These approaches, while using solvents and polymers, do not create doped surface layers that are sensors for matter or energy.

### SUMMARY

The present invention is directed to devices, systems, and methods of making a sensor. In one embodiment of the present invention, a sensor is disclosed. The sensor includes a dopant-containing region at the surface of a solid polymer material. The method of creating a sensor includes a solvent solution containing dopants. The polymer material is impregnated with the dopant by contact with the solution. A polymer/solvent gel-layer, whose depth increases with impregnation time, forms after contact of the polymer material with the solvent solution. The dopants are diffused into the polymer material, forming a dopant-containing region of discrete thickness at a surface of the solid polymer.

The impregnation of the polymer material in the solution may occur by immersing a polymer substrate in the solution, or by injecting the solution into an interior volume or channel in the polymer material. Thus, the polymer material is contacted with the solution. The surface of the original polymer material need not be large or flat or free of surface topography.

The polymer material may be, but is not limited to, polystyrene, polycarbonate, polyvinyltoluene, cyclic olefin copolymer, polymethylmethacrylate, polyacrylic acid, polymethylmethacrylate, poly(ethylene terephthalate), polypropylene, polyethylene, polyvinylchloride, polyester, polyacetate, acrylonitrile butadiene styrene copolymer (ABS), TPE/TPU, nylon, silicone, polyphenylene ether (PPE), polyphthalamide (PPA), polyetherimide (PEI), polyethersulfone (PES), polyaromatic ether ketones (PAEKS), liquid crystal polymer (LCP), polyphenylene sulfide (PPS), or polysulfone (PSU).

In one embodiment, the dopants are confined within the solid polymer to a region at the surface created by the polymer/solvent gel-layer.

The dopants may penetrate to a lesser depth within the solid polymer than the polymer/solvent gel-layer or, alternatively, the dopants may penetrate to an equal or approximately equal depth within the solid polymer as the polymer/solvent gel-layer.

The dopants may be sensitive to matter. In one embodiment, the dopant may be sensitive to a chemical species. In one embodiment, the chemical species is oxygen from a gas phase sample or oxygen dissolved in water or other liquid in the liquid phase.

In one embodiment, the dopants are fluorescent dye molecules.

In one embodiment, the fluorescent dye molecules in the polymer may create a sensor to gaseous oxygen concentrations or oxygen concentrations dissolved in a liquid.

In one embodiment, the fluorescent dye molecules in the polymer may create a scintillator to ionizing radiation.

The solvent may be, but is not limited to, chloroform, acetone, 2-butanone, tetrahydrofuran, acetonitrile, dichloromethane, ethanol, methanol, water, benzene, toluene, carbon tetrachloride, chloroform, diethyl ether, dimethylsulfoxide, dimethylformamide, formamide, n-propanol, isopropanol, n-butanol, ethylbenzene, xylene, mesitylene, pentane, hexane, heptane, petroleum ether, phenol, cyclohexanone, di-isopropyl ether, diethyl ether, or mixtures thereof.

In one embodiment, the sensing layer may be created on one planar surface for point sensing or for chemical imaging.

In one embodiment, a three dimensional sensing layer maybe created at the inside surfaces of a plastic cuvette or a plastic container for cell culture or a plastic container for tissue culture.

In one embodiment, a three dimensional sensing layer may be created inside the surfaces of a plastic microchannel or a plastic microfluidic device.

In one embodiment, an impression is made on the surface of the polymer/solvent gel-layer. The impression creates one or more grooves or microchannels on the surface of the polymer/solvent gel-layer.

The device may further include a top plate which bonds to the impressed polymer material, converting the grooves into enclosed channels. In one embodiment, the dopants are present within the solid polymer in the regions near the side walls and bottom of the grooves or channels.

In one embodiment, the sensor has a surface with a three dimensional solid structure.

The system can include one or more pumps and/or valves to control fluid flow from one channel end to another.

In one embodiment, the grooves of the impressed polymer/solvent gel-layer are up to about 100 μm in depth.

In one embodiment, more than one dopant is diffused into the polymer material. The dopants may be diffused simultaneously, concurrently, or consecutively. As such, in this embodiment, the dopant-containing region of discrete thickness includes more than one dopant—e.g. two or more dopants—at the surface of the solid polymer.

In an embodiment of the present invention, a method of making a sensor is disclosed. The method includes contacting at least one surface of a solid polymer material with a solvent solution containing dopants, wherein the dopants are diffused into the polymer material, forming a dopant-containing region of discrete thickness at a surface of the solid polymer.

In one embodiment, the method may also include stamping the surface of the polymer/solvent gel-layer, which creates one or more grooves on the surface of the polymer/solvent gel-layer, and converting the grooves into channels by bonding a top polymer plate to the impregnated polymer material. The method may also include controlling fluid flow from one channel end to another using one or more pumps and/or valves.

In another embodiment of the present invention, a method of creating a microfluidic sensor is disclosed. The method includes contacting a solid polymer material with a solvent solution containing dopant molecules, creating a polymer/solvent gel layer of discrete time-dependent thickness. The method further includes diffusing the dopant molecules into the gel layer of the polymer and removing the polymer from the solvent solution. The method also includes imprinting a three dimensional structure in the dopant diffused gel layer, and bonding the imprinted layer to a top cover plate.

### BRIEF DESCRIPTION OF THE DRAWINGS

FIGS. 1A-1C are schematic diagrams showing the formation of a distinct gel layer at a solvent exposed surface of a polymer substrate, where the thickness of the gel layer increases with time, in accordance with one embodiment of the present invention.

FIGS. 2A-2C are schematic diagrams showing the formation of a distinct gel layer at a solution exposed surface of a polymer substrate, where the dopant in the solution penetrates the polymer to the same depth as the gel layer. The thickness of the gel layer increases with time, in accordance with one embodiment of the present invention.

FIGS. 3A-3C are schematic diagrams showing the formation of a distinct gel layer at a solution exposed surface of a polymer substrate, where the dopant in the solution penetrates the polymer to a lesser depth than the thickness of the gel layer. The thickness of the gel layer increases with time, in accordance with one embodiment of the present invention.

FIG. 4 shows examples of polystyrene impregnation using acetone and acetonitrile solvents containing a fluorescent dye, recorded with white light (left image) and UV light (right images), with different impregnation times, in accordance with one embodiment of the present invention.

FIG. 5A shows an image of solid polymer impregnation with iodine dye for approximately 5 minutes using an acetonitrile solvent.

FIG. 5B shows an image of solid polymer impregnation with no dye for approximately 23 minutes using an acetonitrile solvent. Taking images before the solvent has completely dried out of the polymer enables visualization of the solvent impregnated region even without a dye to aid visualization.

FIG. 5C shows an image of a solid polymer impregnated with acetonitrile solvents containing NPO dye for approximately 22 minutes, recorded with white light, wherein a distinct gel layer is formed.

FIG. 5D shows an image of the impregnated polymer of FIG. 5C, recorded with UV excitation white, wherein the dye in the solution penetrates the polymer to a lesser depth than the thickness of the gel layer.

FIG. 6A shows an image of solid polymer impregnation using butanone solvent and fluorescent dye for approximately 10 seconds, recorded with both white light and with UV excitation, in accordance with one embodiment of the present invention.

FIG. 6B shows a fluorescent microscopy image of solid polymer impregnation using butanone solvent and fluorescent dye for approximately 10 seconds, recorded with only UV excitation light, in accordance with one embodiment of the present invention.

FIG. 7 shows schematic diagrams for making a microfluidic sensor, in accordance with one embodiment of the present invention.

FIG. 8A shows a 4 cm long microchannel imprinted in a polymer material using a 40 second long impregnation in acetone; the microchannel dimensions measured using a profilometer at its two far ends were 100 μm wide and 35 μm deep, as shown in the inset.

FIG. 8B shows a statistical analysis of 11 samples similar to the microchannel of FIG. 8A, determining the depth and width variation between different imprinting runs.

FIG. 9 shows a comparison between imprinted microchannels using existing solvent-based methods (red profile) and the method described in FIG. 7.

FIG. 10A shows the gel and functionalization thickness dependence on the impregnation duration for acetone and chlorine diffusing into polystyrene.

FIG. 10B shows a three-dimensional reconstructed confocal image of a microchannel formed in polystyrene by impregnation in an acetone solution containing a fluorescent dye, in accordance with one embodiment of the present invention.

FIG. 10C shows the depth of the imprinted features in polystyrene following impregnation in different solvents and for different durations using a 50 μm deep PDMS stamp; the inset plots the profile of imprinted features in polystyrene using pure acetone and 7 μm and 12 μm deep stamps. These show that different solvents create gel layers in the polymer at different rates.

FIG. 11A shows a microfluidic device with cross junction channels in polystyrene, in-filled with a fluorescent ethanol solution; the inset shows a photograph of the same structure, in accordance with one embodiment of the present invention.

FIG. 11B shows a microfluidic device with looping channels in polystyrene, in-filled with a fluorescent ethanol solution, similar to FIG. 11A, in accordance with one embodiment of the present invention.

FIG. 11C shows a three dimensional confocal image of a microchannel in-filled with a dye solution, in accordance with one embodiment of the present invention.

FIG. 12A is a schematic diagram of a microfluidic sensor wherein the sensitized layer contains a microchannel capped by a cover plate, in accordance with one embodiment of the present invention.

FIG. 12B is a confocal image of a bonded polystyrene microchannel formed impregnation in a fluorescent chloroform solution; the inset shows the cross-sectional fluorescence intensity distribution across the channel, in accordance with one embodiment of the present invention.

FIG. 12C shows a series of FLIM snapshots following the transport of gaseous oxygen diffusion in a microchannel described in 12B, in accordance with one embodiment of the present invention. The influx of oxygen reduces the fluorescent lifetime, which then appears darker, showing the sensing of oxygen by the dye impregnated in the plastic.

FIG. 12D is a plot of the phosphorescence lifetime in response to oxygen as a function of time (x-axis) and distance (y-axis). The influx of oxygen reduces the fluorescent lifetime, which then appears darker, showing the sensing of oxygen by the dye impregnated in the plastic.

FIG. 13A shows a pore-scale design of a dense system of microchannels (on the right) and amplified contours of at least one of the dense system of microchannels (on the left), in accordance with one embodiment of the present invention.

FIG. 13B shows a mixed microbial culture in a microchannel for Shewanella and Flavobacteria expressing different fluorescent proteins; the inset shows the number of cells as a function of time. This illustrates that microfluidic devices and sensors according to embodiments described herein can be used in cell culture.

FIG. 13C shows the growth curves of the Clostridium thermocellum for cells grown in polystyrene micro-scale pore models (blue) and under ideal culture conditions (red); inset shows a photograph of a sealed micromodel. This illustrates that microfluidic devices and sensors according to embodiments described herein can be used in cell culture.

FIG. 14 shows an image of a polystyrene cuvette under UV illumination, where the inside surfaces of the cuvette have been impregnated with NPO dye by injecting dye solution in 2-butanone into the cuvette with a pipette, contacting the inside surfaces with the dye solution and then withdrawing the solution and letting the plastic dry. The inside surfaces, seen as gray in this gray scale image, emit fluorescent light.

FIG. 15A shows an image of two PtTFPP impregnated polystyrene cuvettes under visible light. The interiors of both cuvettes are impregnated identically and the red-colored dye is apparent. The cuvette on the left is purged with nitrogen to remove oxygen, while the cuvette on the right is exposed to oxygen in the air.

FIG. 15B shows an image of the same two PtTFPP impregnated polystyrene cuvettes of FIG. 15A, but under UV light which excites the luminescence of the PtTFPP dye. The cuvette whose interior is purged with nitrogen has a much brighter luminescence than the cuvette whose interior surface is exposed to oxygen in the air, demonstrating oxygen sensing by the dye-impregnated layer on the interior of the polystyrene device.

FIG. 16A shows a blank disc and a PtTFPP dye impregnated disc.

FIG. 16B is a white light image of the PtTFPP impregnated disc of FIG. 16A under nitrogen flow.

FIG. 16C is a long wave UV image of the PtTFPP impregnated disc of FIG. 16A, showing PtTFPP luminescence in line with the tube delivering nitrogen, where nitrogen flow excludes oxygen.

FIG. 17 shows an image of a plastic microchannel device featuring a single inlet and a single outlet coupled by a single channel, in accordance with one embodiment of the present invention.

FIG. 18 shows the count rate response for a solid polymer impregnated with acetonitrile solvents containing NPO dye, compared to a non-treated polymer, and exposed to ⁹⁹Tc in water. This illustrates that the solid polymer impregnated by a solvent solution containing dopants can be used as a scintillator or radiation sensor.

### DETAILED DESCRIPTION OF THE PREFERRED EMBODIMENTS

The following description includes the preferred best mode of embodiments of the present invention. It will be clear from this description of the invention that the invention is not limited to these illustrated embodiments but that the invention also includes a variety of modifications and embodiments thereto. Therefore the present description should be seen as illustrative and not limiting. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

Disclosed are sensors, devices, apparatuses, systems, and methods of making a sensor by altering the surfaces of plastic substrates in technically useful ways. The sensor can be, but are not limited to, radiation sensors, oxygen sensors, and diabetes sensors. The sensor is created as an impregnated layer in the surface of the polymer material.

In one embodiment, a polymer material is contacted with a solvent solution containing dopants. The polymer substrate may be immersed in the solution, or a solution may be injected into the interior of a polymer structure that contains voids, grooves, microchannels, or wells, thus contacting the solution with the polymer material. Solvent molecules diffuse into the polymer material. When sufficient solvent has diffused into the polymer, a gel layer is created in the surface region of the polymer. This creates a discrete polymer-solvent gel-layer at the solvent exposed surface of the polymer substrate, with an interface between the gel layer and the bulk polymer material. The thickness of this gel layer increases with time, at rates depending on the polymer, the solvent, and the temperature. Dopants in the solution may also diffuse in to the polymer, including into the gel layer. Thus, the sensing compound is incorporated into the polymer material, as opposed to being contained in a separate applied thin layer, for example, by solvent casting.

After removal of the solution, and drying of the solvent out of the polymer, the bulk polymer material and the polymer material in the surface region containing the dopant remains essentially the same material, as opposed to applied thin films where the underlying substrate is one material and the applied thin layer is another material.

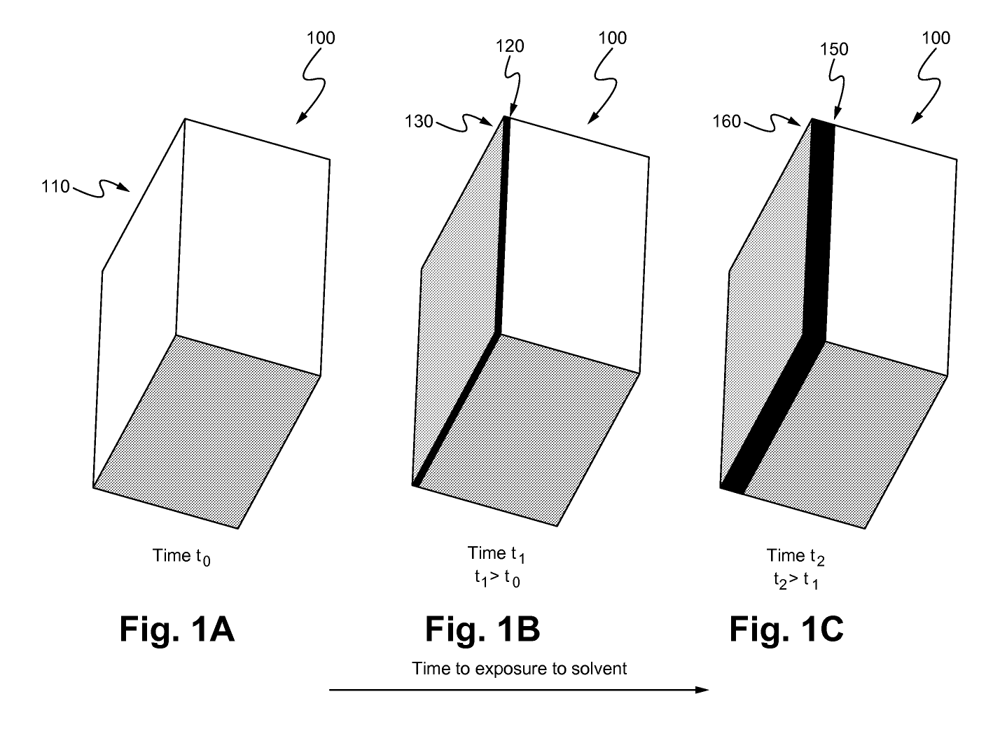

FIGS. 1A-1C are schematic diagrams showing the formation of a distinct gel layer at a solvent exposed surface of a polymer substrate, where the gel layer thickness increases with time, in accordance with one embodiment of the present invention for making a sensor. In FIG. 1A, a solid polymer material 100 is shown with a surface 110 side which will be exposed to a solvent. At time t₀, the polymer material 100 has zero exposure to the solvent. In FIG. 1B, the solid polymer material 100 has been exposed or contacted with the solvent at time t₁, with t₁>t₀. A discrete gel layer 130 is formed along with an interfacial boundary 120 between the gel layer 130 and the solid polymer material 100. The thickness of the discrete gel layer increases with time. In FIG. 1C, at time t₂, with t₂>t₁, a thicker discrete gel layer 160 has formed on the solid polymer material 100, as the boundary layer 150 progresses inward.

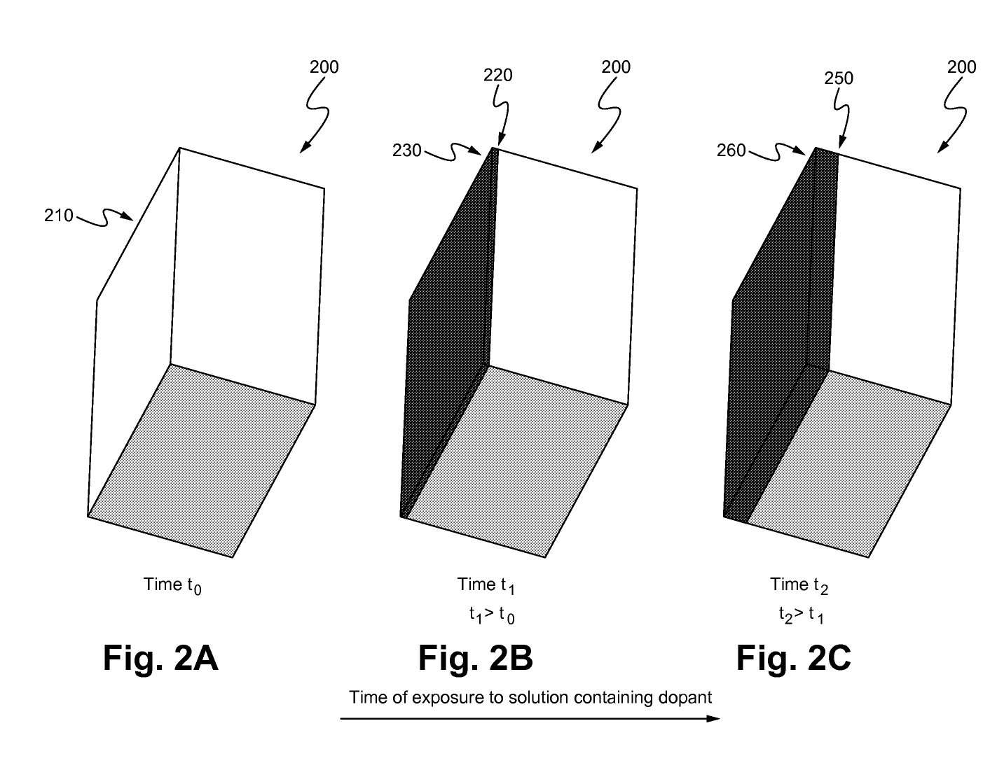

FIGS. 2A-2C are schematic diagrams showing the formation of a distinct gel layer at a solution exposed surface a polymer substrate, where the dopant in the solution penetrates the polymer to the same depth as the gel layer. The thickness of the gel layer increases with time, in accordance with one embodiment of the present invention for making a sensor. In FIG. 2A, a solid polymer material 200 is shown with a surface 210 side which will be exposed to a solvent solution containing dopants. At time t₀, the polymer material 200 has no exposure to the solvent. In FIG. 2B, the solid polymer material 200 has been exposed or contacted with the solvent at time t₁, with t₁>t₀. A discrete gel layer 230 impregnated with dopants is formed along with an interfacial boundary 220 between the gel layer 230 and the solid polymer material 200. The thickness of the discrete gel layer increases with time. In FIG. 2C, at time t₂, with t₂>t₁, a thicker discrete gel layer 260 has formed on the solid polymer material 100, as the boundary layer 250 progresses inward. As shown in FIGS. 2B and 2C, the dopant penetrates the same or similar depth as the gel layer.

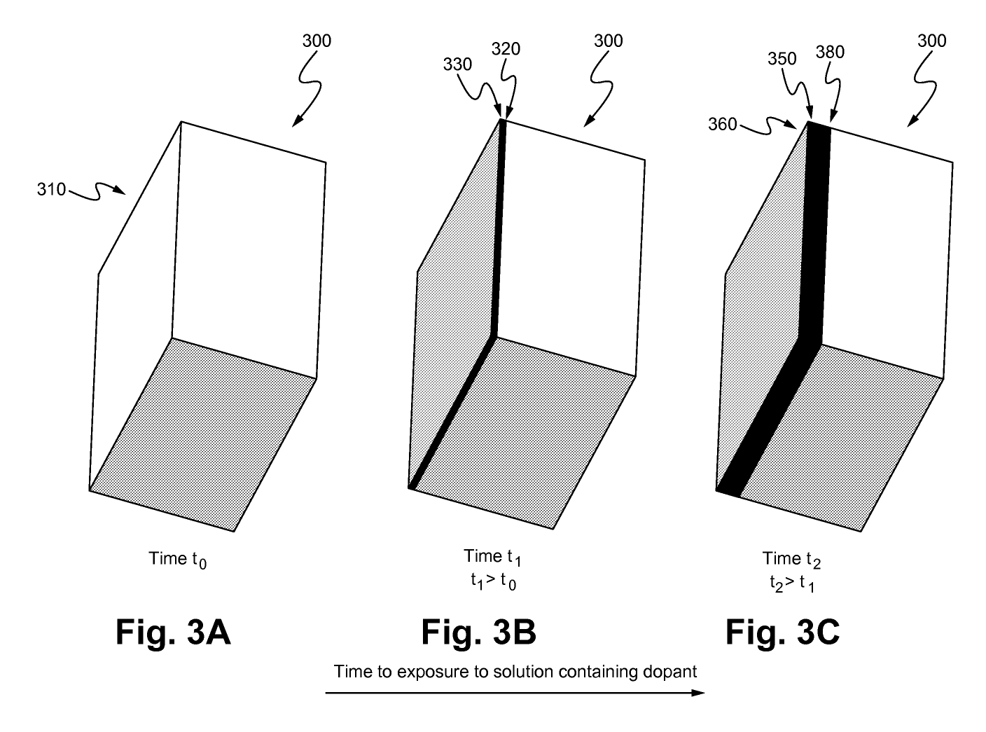

FIGS. 3A-3C are schematic diagrams showing the formation of a distinct gel layer at a solution exposed surface of a polymer substrate, where the dopant in the solution penetrates the polymer to a lesser depth than the thickness of the gel layer. The thickness of the gel layer increases with time, in accordance with one embodiment of the present invention for making a sensor. In FIG. 3A, a solid polymer material 300 is shown with a surface 310 side which will be exposed to a solvent solution containing dopants. At time t₀, the polymer material 300 has no exposure to the solvent. In FIG. 3B, the solid polymer material 300 has been exposed or contacted with the solvent containing dopants at time t₁, with t₁>t₀. A discrete gel layer 330 is formed along with an interfacial boundary 320 between the gel layer 330 and the solid polymer material 300. The dopant has not penetrated into the polymer 300 as deep as the solvent has penetrated forming a gel layer. The thickness of the discrete gel layer increases with time, while the dopant diffuses into the polymer to a depth less than the thickness of the gel layer. In FIG. 3C, at time t₂, with t₂>t₁, a thicker discrete gel layer 350 has formed on the solid polymer material 300, as the boundary layer 380 progresses inward. The dopant also diffused into the polymer gel layer creating a near surface region 360 containing dopant that is not as thick as the gel layer 350. As shown in FIGS. 3B and 3C, the dopant penetrates to a lesser depth than the gel layer.

The dopants may be sensitive to a chemical species. Further, the dopants may be sensitive to a gas in a gas phase or dissolved in a liquid phase. The gas may be oxygen in the gas phase or oxygen dissolved in water in the liquid phase. In one embodiment, the dopant is a fluorescent molecule whose fluorescence intensity and lifetime decrease with increasing oxygen concentration. Other types of sensors may also be created.

In one embodiment, the dopants are fluorescent dye molecules. The fluorescent dye molecules in the polymer can create a scintillator that senses ionizing radiation. Other types of sensors may also be created.

The sensor may be created by immersing a piece of plastic in a dye containing solution, thus creating sensing material at the outer surfaces of the plastic. The sensor may be created by exposing only a single outer surface, or a portion of an outer surface.

Sensors may also be created by contacting the interior surfaces, or an interior surface, or a portion of an interior surface, of a plastic container, with dye containing solution.

Sensors may be created by contacting interior surfaces of plastic microchannels with dye containing solutions, thus creating microfluidic sensors where the dye is only present along the interior surfaces of the microchannels. Fluid structure and sensor imaging thus coincide spatially.

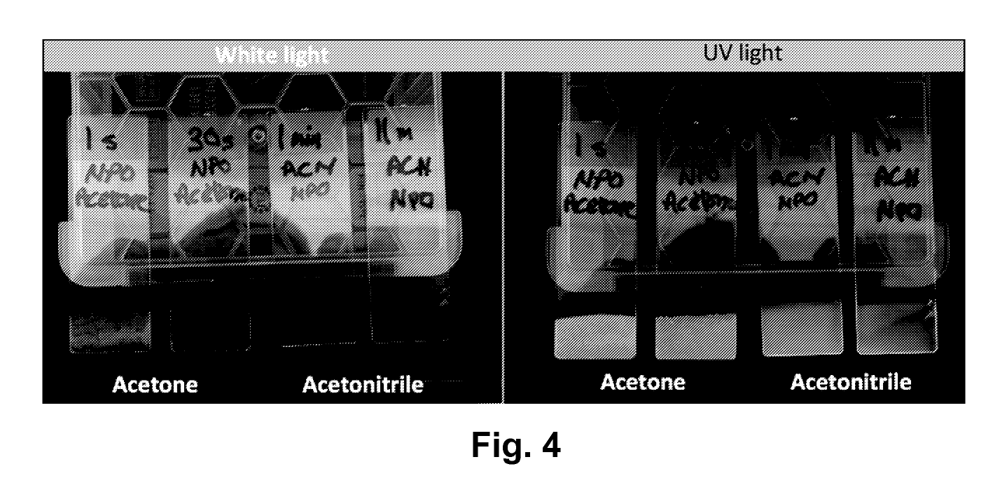

The solvents may be, but are not limited to chloroform, acetone, 2-butanone, tetrahydrofuran, acetonitrile, dichloromethane, ethanol, methanol, water, benzene, toluene, carbon tetrachloride, chloroform, diethyl ether, dimethylsulfoxide, dimethylformamide, formamide, n-propanol, isopropanol, n-butanol, ethylbenzene, xylene, mesitylene, pentane, hexane, heptane, petroleum ether, phenol, cyclohexanone, di-isopropyl ether, diethyl ether, or mixtures thereof. FIGS. 4 through 6 show impregnation of polystyrene plastic with dyes using solvents including acetonitrile and butanone (discussed further below).

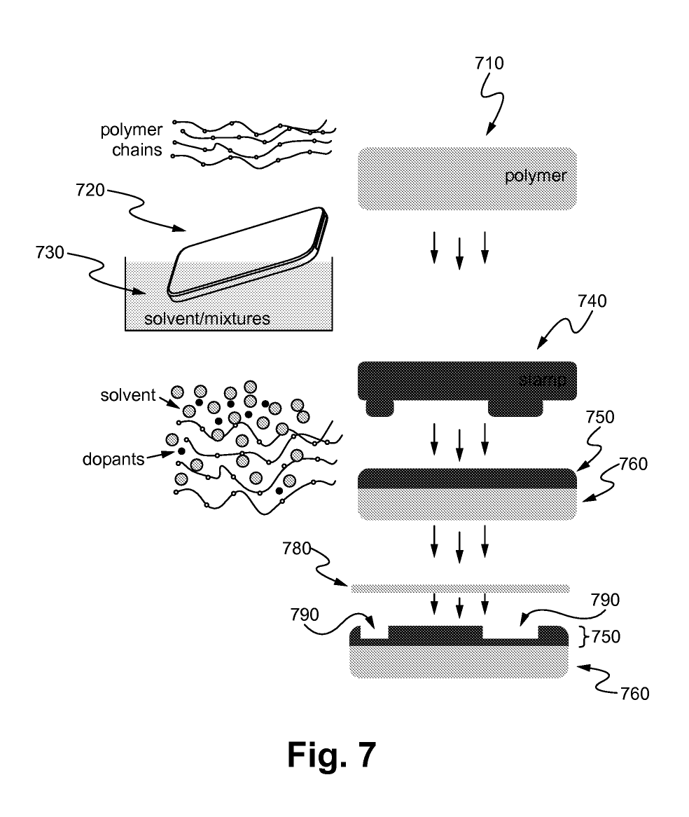

FIG. 7 shows schematic diagrams for making one embodiment of a microfluidic sensor, in accordance with one embodiment of the present invention. A polymer material, slab or film 710 is shown comprising polymer chains. The polymer material 710 is then impregnated in a solvent solution 730 which contains dopants, during which the solvent solution 730 penetrates 720 into the polymer forming a softened surface layer 720. A discrete gel layer 750 is formed in the surface of the polymer, and this gel layer contains polymer chains, solvents, and dopants. A stamp 740 is pressed against the gel layer 750 of the polymer 760 for a predetermined amount of time in order to enable the pattern transfer from the stamp to the polymer. The pressing of the stamp 740 against the discrete gel layer 750 produces, in this example, two grooves 790 in the discrete gel layer. It should be noted that different imprinting patterns of the stamp 740 may produce more or less impressions or grooves on the surface of the polymer/solvent gel layer. A top plate 790, which may be made of plastic, is placed on top of the impression. The top plate 790 bonds to the impressed polymer material, converting the grooves 790 into enclosed channels.

The dopants are present in the polymer/solvent gel layer 750 near the side walls and the bottom of the grooves 790 or channels. One or more pumps and/or valves can be included to control fluid flow within the channels. In one embodiment, the grooves 790 of the impressed polymer/solvent gel layer 750 are up to about 100 μm in depth.

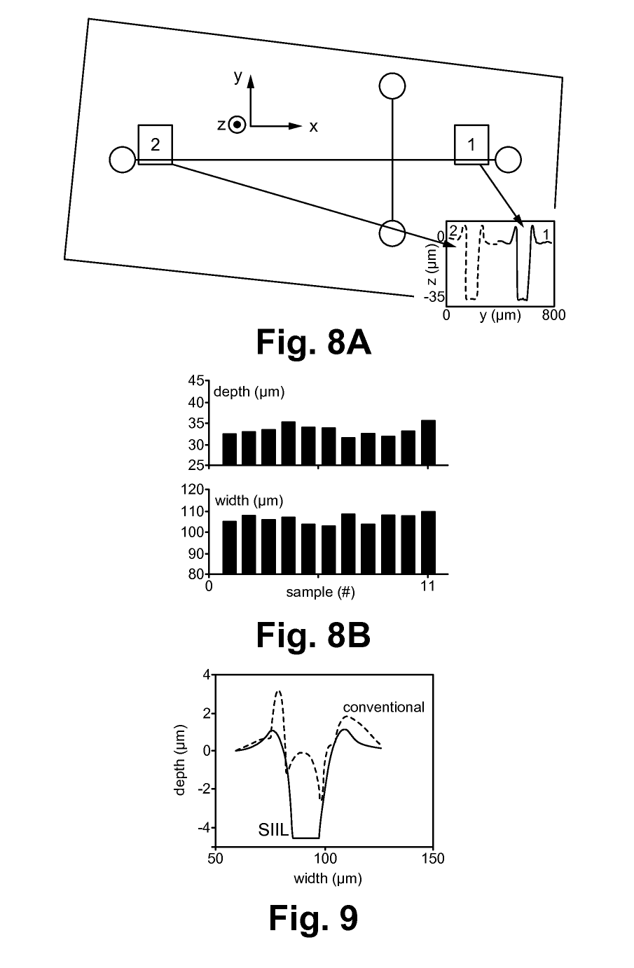

FIG. 8A shows a 4 cm long microchannel imprinted in a polystyrene material using a 40 second long impregnation in acetone; the microchannel dimensions measured using a profilometer at its two far ends were 100 μm wide and 35 μm deep, as shown in the inset. Such large area patterning exhibited high quality with minimal variation across the entire imprinted surface as confirmed by the profilometer measurements. Since the dopant can be impregnated in polymer surfaces of large area by immersion in solution, and large areas can be imprinted as well, large microfluidic sensor devices may be created.

FIG. 8B shows a statistical analysis of 11 samples similar to the microchannel of FIG. 8A, determining the depth and width variation between different imprinting runs. The statistical analysis revealed minimal variation in width and depth between the 11 different imprinting runs with 2.9 μm (2.6%) and 1.2 μm (3%) respectively.

FIG. 9 shows a comparison between imprinted microchannels using existing or conventional solvent-based methods (red profile) and the method described in FIG. 7. The same imprinting conditions were employed, namely a 20″ imprinting duration, acetone as a solvent, a 5 μm deep PDMS stamp and the same exerted force enabled by a 500 gr weight. As shown in FIG. 9, polymer imprinting into a surface gel layer by the methods disclosed herein provides better control over the impression structure compared to background conventional methods that do not use solvent immersion to first create a gel layer.

### Experimental Section

The following examples serve to illustrate embodiments and aspects of the present invention and should not be construed as limiting the scope thereof.

### Example 1

### Oxygen Sensors by Plastic Impregnation Using Solvent Containing Dopants or Dyes

### 1. Impregnation Approach

Creation of oxygen sensors by impregnating fluorescent oxygen sensing dyes or dopants into the surface region of the plastics entails the following parameters, in accordance with one embodiment of the present invention.

a) Fluorescent dyes. Two dyes for oxygen sensing will be noted in the example herein. First, films containing Pt(II) meso-tetra(pentafluorophenyl) porphine (PtTFPP) will be used. This fluorophore is noted for its excellent stability to photobleaching and sensitivity to oxygen. Second, the hexanuclear molybdenum cluster, K2Mo6Cl14, can be impregnated in plastic surfaces. Both dyes are soluble in solvents suitable for the solvent impregnation processes.

The molybdenum cluster dye is much longer-lived than any existing commercial oxygen sensing dye, which opens new applications for oxygen sensing devices. However, the encapsulation of this dye in a polymer material is useful to its function, and challenging by conventional thin film formulation and coating methods. The impregnation of plastic materials with this dye provides a simpler and more robust oxygen sensor than is achievable by current methods.

In addition, 2-(1-naphthyl)-5-phenyl-oxazole (NPO) dye will be used in experiments that characterize the solvent impregnation method.

b) Polymers. The focus is in this example is on polystyrene. Polystyrene is a well known matrix for optodes for oxygen sensing, as it has a higher oxygen permeability than typical glassy or thermoplastic polymers for oxygen diffusion. While it is not as permeable as polydimethylsiloxane (PDMS), another plastic used for oxygen sensors, very thin surface layers can be created by the impregnation technique of the present invention, which will offset this lower permeability, and represents an advantage of the new method. In addition, polystyrene-based oxygen sensors provide signals over a wider dynamic range than PDMS-based oxygen sensors using the same dye. Polystyrene is also a known material for creation of microfluidic devices by imprinting methods, and furthermore, is a preferred material for cell culture applications (unlike PDMS). Polystyrene is conveniently available as microscope slides for fluorescent microscopy.

c) Solvent. The solvents examined are those that participate in the Case II sorption process, described in Windle, A. H. (1986) Case II Sorption, in Polymer Permeability (Comyn, J., Ed.) pp 75-118, Springer, Netherlands, while also serving as a solvent for the fluorophore. Some solvents are relatively benign and slow to penetrate polystyrene, while others are more aggressive. The gel layer develops slowly with acetonitrile, on the order of minutes, while a solvent like butanone can create a gel layer in a matter of seconds. All these solvents can impregnate fluorophores. FIG. 4 illustrates impregnation of an “NPO” fluorophore dye into polystyrene slides, which are microscope slides made of polystyrene, using acetone and acetonitrile. Both solvents impregnate the dye. UV light shows the fluorophore that has been impregnated.

d.) time and temperature. Room or ambient temperature is typically used, and the time varies. The time it takes to create gel layers of various thicknesses depends on the solvent. For sensor fabrication, a thin sensitive layer will be created at the surface in order to be responsive. Thicker layers may provide more fluorophore for the signal, while thinner layers are expected to respond more rapidly.

### 2. Impregnation Characterization

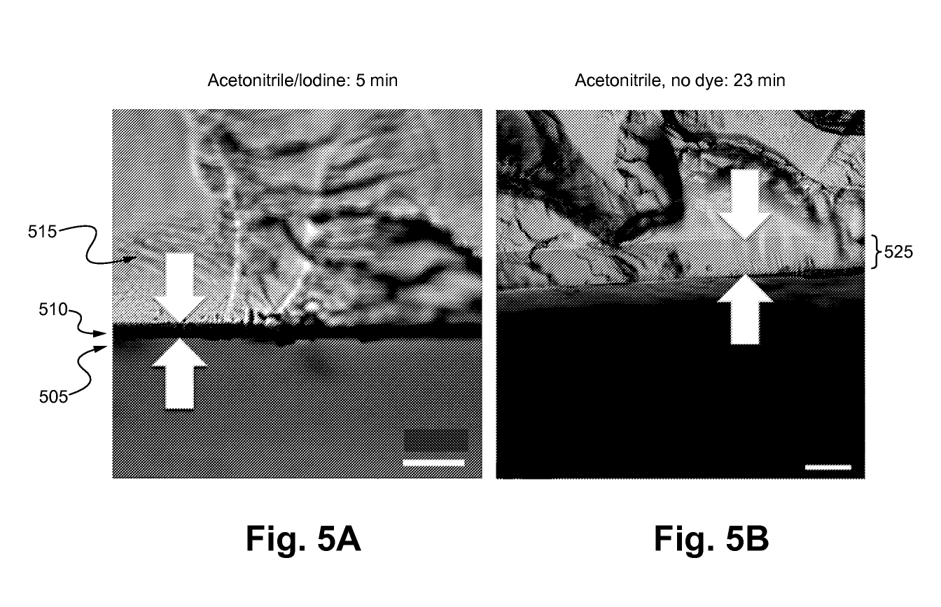

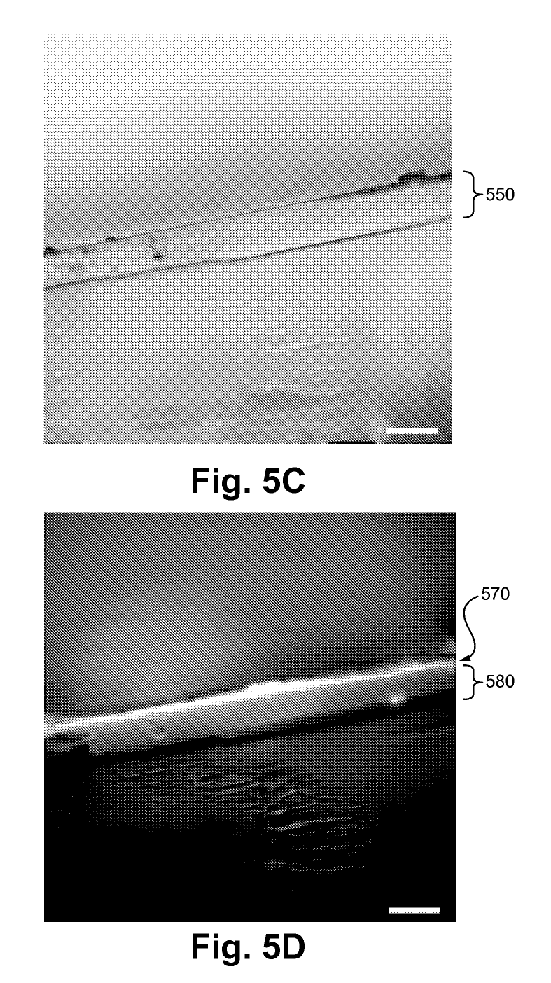

The creation of the gel layer, its depth with time, and the penetration of the dye with the solvent were determined by characterizing the polymers normal to the planar surface. The surfaces were fractured and microscopy performed to image these surfaces. While solvent impregnation with iodine does help to visualize the gel layer depth, as shown experimentally in FIG. 5A, it turns out that gel layer formation alters the refractive index of the polymer sufficiently to visualize the interface in bright field. Hence, if the surface is fractured and observed before the solvent has completely evaporated and dried out the polymer, the layer and its interface with the bulk polymer maybe visualized without a dye to facilitate visualization. After long drying periods, this interface is no longer viable, as the polymer from which the solvent has evaporated is the same as the original bulk solvent, albeit with a dopant if a dopant was included in the solvent solution. FIG. 5A shows an image of impregnation of polystyrene for approximately 5 minutes using an acetonitrile solution containing iodine. The image shows the edge of the polystyrene slide 505, the surface region doped with iodine 510, and the bulk polymer side 515 with little or no iodine present. FIG. 5B shows a result of solid polymer impregnation for approximately 23 minutes with no iodine or fluorescent dye in the acetonitrile solvent. A discrete layer 525 is apparent. These images were collected with a microscope after fracturing impregnated slides to expose a surface normal to the top of the slide.

FIG. 5C shows an image of a solid polymer impregnated with acetonitrile solvents containing NPO dye for approximately 22 minutes, recorded with white light, wherein a distinct gel layer 550 is formed.

FIG. 5D shows an image of the impregnated polymer of FIG. 5C, recorded with excitation white, wherein the dye 570 in the solution penetrates the polymer to a lesser depth than the thickness of the gel layer 580.

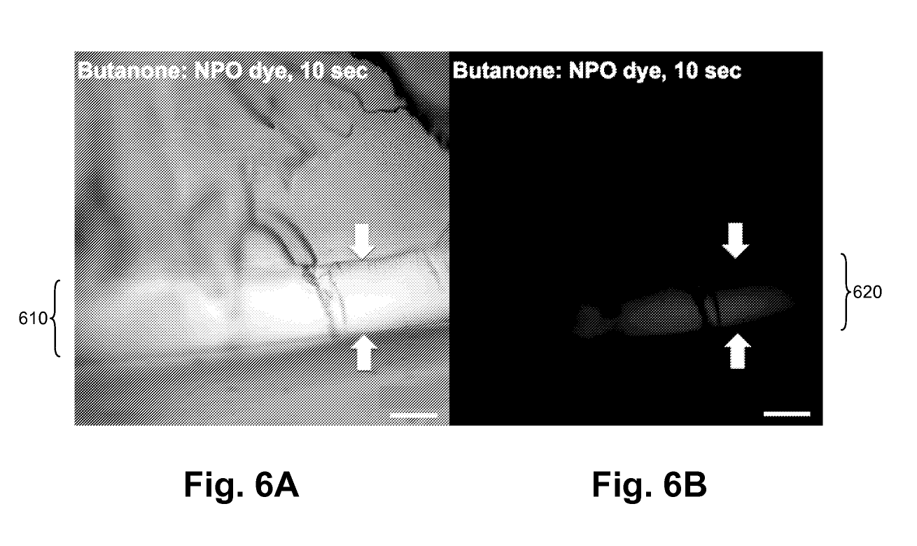

Furthermore, using the fluorescent capabilities, incorporation of a fluorescent dye, NPO, is shown in FIGS. 6A and 6B using butanone solvent and the NPO dye; fluorescence is found at the full depth of the gel layer 610 (FIG. 6A) and 620 (FIG. 6B). The image of FIG. 6A was recorded with both white light and with fluorescent excitation, while the image of FIG. 6B was recorded with purely a fluorescent microscopy image. It has been noted in these experiments that much shorter solvent impregnation times (10 sec) in butanone lead to thicker gel layers compared to even 23 minutes in acetonitrile (FIG. 5B).

### 3. Oxygen Sensing Performance

Oxygen sensing is of interest for oxygen sensing in gas phases, and dissolved oxygen sensing in aqueous phases. Oxygen sensing may be demonstrated by measuring fluorescent intensity or fluorescent lifetime as a function of oxygen concentrations, as is known in the state of the art using a variety of optical methods, including time domain and frequency domain methods. Imaging across areas of oxygen sensor and microfluidic oxygen sensors can be carried out by techniques such as scanning or camera method. In some experiments, an inverted microscope (Leica DMI6000), coupled with a Fluorescence Lifetime Imaging setup (LI2CAM-P, Lambert Instruments, Netherlands), was used. In some experiments, for measurements on PtTFPP fluorophore, an LED light source centered at 395 nm was modulated at 5 kHz, and the 650 nm luminescence emission intensity was measured.

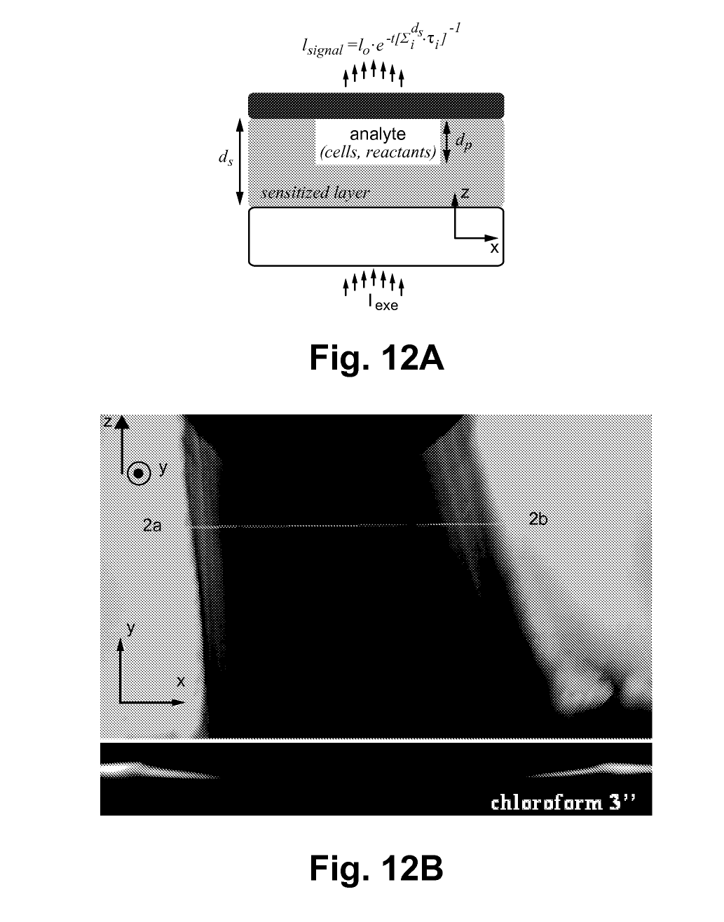

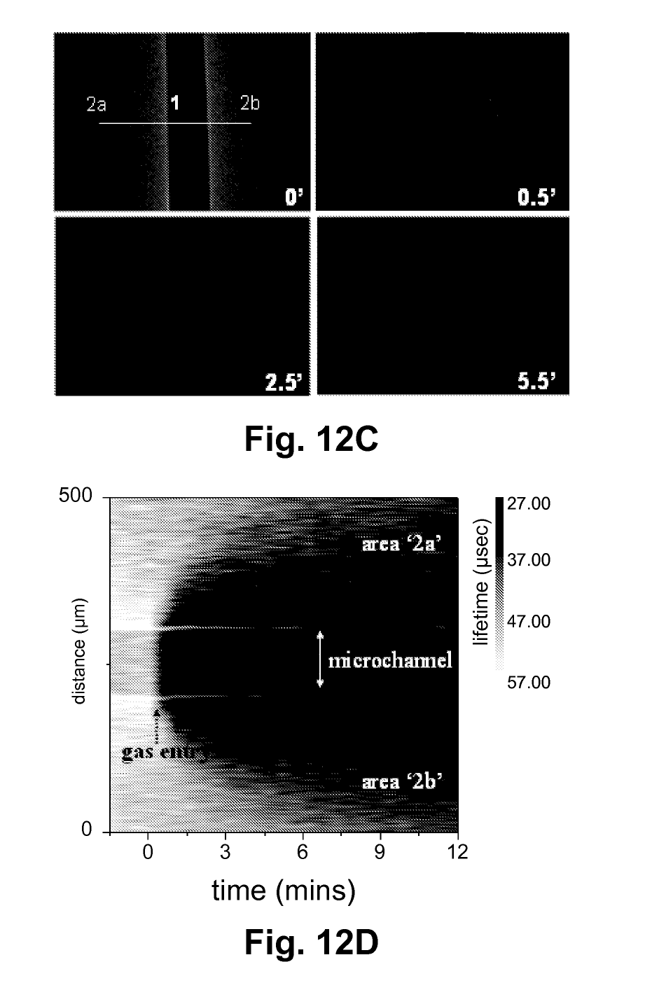

FIG. 12D shows fluorescent lifetime images in tall thin strips, with strips from the same physical location, image at separate times, placed side by side as time progresses along the x-axis of this image. The y-axis is the distance across the device with the microchannel in the middle. At the beginning of the experiment the microchannel has been purged of oxygen and the image records lighter areas with longer fluorescent lifetime. As oxygen diffusion into the microchannel occurs with time, moving right on the x axis for successive thin tall images, it is seen that the microchannel region turns dark because the oxygen has been sensed as a decrease in fluorescent lifetime. As time continues, it is also seen that the plastic along each side of the microchannel becomes darker, as oxygen diffused into the bulk of the plastic and so the fluorescence lifetime is shorter and the image shows this as a darker shade. Thus, polystyrene plastic impregnated with the PtTFPP dye by the methods disclosed herein acts as an oxygen sensor. Since the device in this case has also been imprinted with a channel, the example further illustrates a microfluidic oxygen sensor. This last aspect will be described in more detail in EXAMPLE 2.

### Example 2

### Microfluidic Sensors, Polymer-Solvent Impregnation and Imprinting

In this example, experimental investigations of polymer-solvent interactions, specifically in relation to functionalization and deep feature imprinting, are disclosed. Polystyrene microfluidics, cell growth microbioreactors and microstructured oxygen sensors are demonstrated herein, with typical processing times of less than about two minutes.

### Materials

The polymers used in the experiments, namely polystyrene and PMMA were supplied by GoodFellow (USA) at various thicknesses ranging from 1.5 mm to 0.25 mm. All organic solvents were supplied by Sigma Aldrich (USA), while purified deionized water was employed where mentioned. The oxygen sensing fluorophore (PtTFPP) employed in the optofluidic experiment was supplied by Frontier Scientific (USA) and solutions were prepared at a concentration of 0.5 mg/ml. The stamps were made by conventional cast-molding lithography in PDMS. The PDMS (Sylgard 184, Dow Corning, USA) was mixed with the catalyst at 1:10 ratio, degassed for approximately 1 h, baked at 70 C for 1 h, removed from the hard SU8 mask and baked for an additional 1 h. The hard SU8 mask was fabricated with conventional contact mode optical lithography using the MicroChem formulations SU8-2000. The photoresist was spin coated onto Si 4″ wafers at different speeds to control its thickness. For confocal imaging, two different chromophores were used depending on the solvent, both supplied by Sigma Aldrich; fluorescein was mixed with acetone and Nile Red with acetone and chloroform at approximately 1 mM concentration.

### Imaging

The fluorescent imaging of the gel layer was performed in an inverted microscope (Leica DMI6000), coupled with a spinning disk confocal system (Yokogawa, CSU10). A 20× objective was used (20×/0.7 NA Plan Apo DIC Optics Inclusive) and the z-scanning was performed at a 2 μm step size and the gel film thickness was estimated by intensity thresholding. For the latter the background level was estimated by the ratio of the standard deviation over the mean. Oxygen sensing was performed in a Fluorescence Lifetime Imaging setup (LI2CAM-P, Lambert Instruments, Netherlands), integrated with the aforementioned Leica inverted microscope. For this measurement, an LED with an emission spectrum centered at 399 nm was employed modulated at 5 kHz.

### Microfluidics

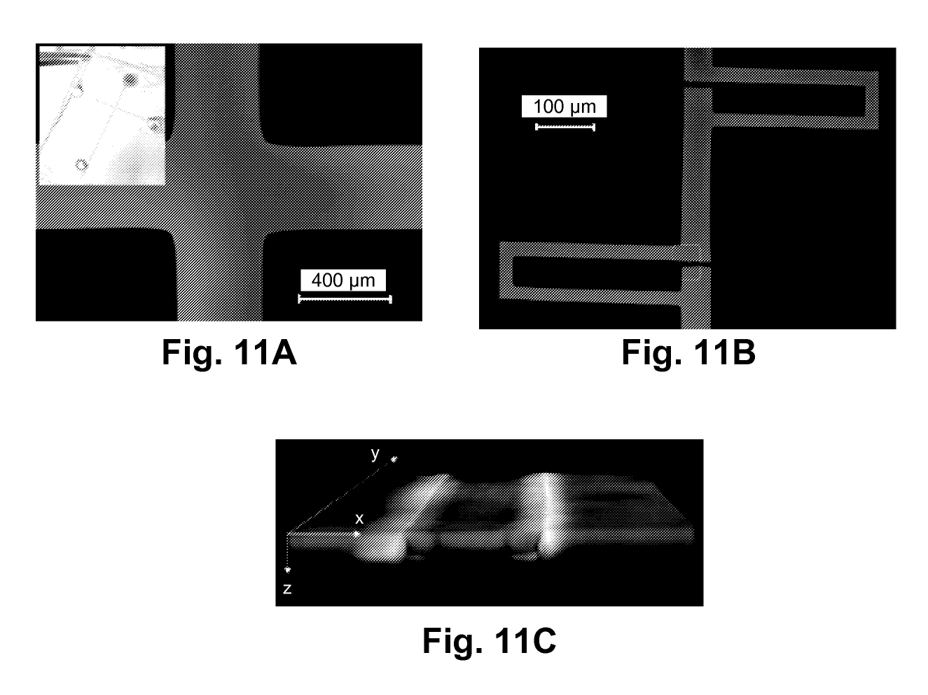

In the microfluidic experiments, a peristaltic pump, capillary forces or manual means were employed to inject fluids. The microbial cells were manually injected in the micromodels using a syringe. The filling of the polystyrene microchannels for fluorescent imaging, e.g. FIGS. 11A-D, was performed by capillary action, using a fluorescein ethanol solution. Flow rate control, where stated, was provided by a precision milliGAT pump (Global FIA, USA), connected to the microfluidics with Nanoport fittings through PTFE tubing.

### Cell Cultures

Clostridium Thermocellum ATCC 27405 cultures were grown in complex GS-2 media, at 60° C. under strict anaerobic conditions. In these media, cellubiose was the main carbon source. Batch growth rate experiments were performed in 50 mL volumes, under shaking conditions. Cell densities were measured by removing 1 mL aliquots of culture, and measuring absorbance at 600 nm using a BioRad spectrophotometer (Bio Rad, Hercules, Calif.). The aerobic bacterial strains, Shewanella and Flavobacteria were grown in a bicarbonate-buffered media containing glucose as the sole carbon source. These were a spontaneous variant of Shewanella oneidensis MR-1 engineered to express a green-fluorescent protein, and Flavobacterium johnsoniae UW101 expressing the mStrawberry fluorescent protein. Batch cultures were incubated under aerobic conditions at 30° C. Prior to growth experiments, the biomass was grown overnight and subsequently transferred at 1% inoculum into fresh media.

### Polymer-Solvent Interactions

While several methods exist in the literature to investigate polymer-solvent interaction, fluorescent microscopy was employed in order to combine the diffusion with the imprinting investigations. Once dried, the films were imaged by fluorescent confocal microscopy along the film depth (z-axis). Similar procedures have been previously reported in interfacial polymer dissolution studies; however, in the present experiments confocal imaging was chosen to characterize substrates that can be specifically used in microfluidic applications.

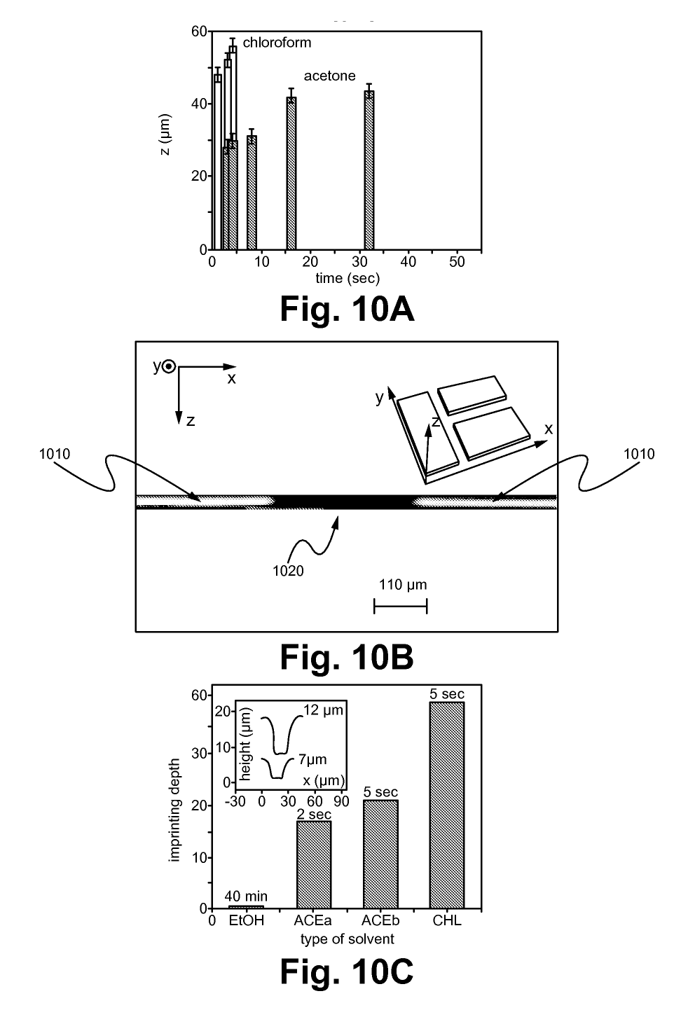

Typical results are shown in the histogram of FIG. 10A for different immersion durations, illustrating that the solvent diffusion depth increases for longer immersions. The solvent diffusion depth was also found to depend on the solvent type. Polymer/solvent interactions are frequently described by the Hildebrand solubility parameter, which states that the closer the solubility parameters between two substances are, the easier it is to mix them. The Hildebrandt parameters, δ, for chloroform and acetone are 18.7 and 20.4 (J/cm³)^{1/2}, respectively, while the one for polystyrene is 18.7 (J/cm³)^{1/2}. The solvent diffusion depth was substantially thicker in chloroform than acetone for similar immersion durations, as shown in FIG. 10A. This likely occurs because of chloroform's higher thermodynamic compatibility with polystyrene, as evidenced by their matching Hildebrandt parameters.

### Solvent Immersion Imprinting

To explore the formation of a surface gel layer, polystyrene films were immersed in a fluorescent solution and subsequently pressed against a patterned PDMS slab, as described in FIG. 7. During this process, the PDMS pattern is transferred to the fluorescent gel of the immersed polystyrene, while the porosity of PDMS enables the solvent evaporation. The latter enables rapid solvent removal from the polymer while still in contact with the PDMS. Solvents with higher vapor pressure evaporate faster and result in more uniform surfaces.

FIG. 10B shows a 3-dimensional reconstructed confocal image across a microchannel formed in polystyrene by immersion in a fluorescent acetone solution and imprinting. The dye is present in the polymer surface region 1010, while a microchannel 1020 imprinted in the surface layer is dark. A residual thin fluorescent layer remained below the imprinted area 1020.

The imprinting depth can be controlled by multiple parameters. If the stamp features are higher than the gel layer thickness, the gel layer thickness will limit the depth to which the stamp penetrates the polymer, as the stamp will stop when it encounters the harder bulk polymer material at the gel layer/bulk polymer interface. This solvent dependence is illustrated in FIG. 10C for a 50 μm thick PDMS stamp and 2 second immersion duration in both chloroform and acetone. Despite the same immersion duration, chloroform gave rise to deeper imprinted features due to its having created a deeper gel layer. In the case of ethanol, no imprinting was observed even after 40 minutes of immersion; ethanol is ineffective at creating a gel layer in polystyrene. Longer solvent immersion, also gives rise to thicker gels and thus to deeper features. This is also shown in FIG. 10C for a 2 second and 8 second immersion in acetone and employing the same 50 μm thick PDMS stamp. The same pressure was exerted in all experiments of FIG. 10C by positioning a light weight (approximately 500 grams) on top of the polymer slabs. Another means of controlling the imprinted features is the height of the stamp's features. This is illustrated in the inset of FIG. 10C for a polystyrene immersion in acetone and using a 7 μm and a 12 μm deep stamp, which results in equivalently different imprinting depths. Control of the imprinting depth via the stamp height was substantially more practical. These examples illustrate how the channel features in a microfluidic sensor, wherein a dopant is included in the solution that creates the gel layer, can be controlled by the gel layer formation and imprinting methodology.

### Imprinting

A polymer slab or film is initially immersed in the solvent to create the gel layer in the polymer surface, as described above in connection with FIG. 7. For polystyrene, a 30-40 sec long impregnation or immersion in acetone was generally employed, unless stated otherwise. Subsequently, a PDMS stamp was pressed against the immersed polymer for approximately 8-10 seconds in order to enable the pattern transfer from the stamp to the polymer. To assist the pattern transfer, light weights (500 grams) with manual pressing was applied; alternatively a manual press can be employed. Following this, the solvent is removed from around the polymer, while the latter is kept still in contact with the PDMS stamp. This forms type ‘A’ approach. Alternatively, the polymer can be first removed from the solvent and be subsequently imprinted under atmospheric conditions (type ‘B’). This expedites the process by 1 minute; however the imprinted features may suffer from surface inhomogeneities which do not occur in the type ‘A’ approach. Similar to previously reported solvent-assisted nanoimprinting, PDMS was chosen as the stamp material for its non-adhesion properties as well as to permit excess solvent evaporation. Imprinting takes place via the flow driven re-organization of the softened gel under mechanical pressure. To this end, care needs to be taken to provide a uniform imprinting pressure and avoid feature distortion due to incomplete gel reflow.

### Bonding

Following imprinting and solvent removal, the PDMS stamp is removed and the polymer is gently pressed against a non-treated polystyrene surface to permanently bond. Provided that the period from solvent separation until imprinting is not too long (i.e. no longer than 20 sec-25 sec for polystyrene-acetone), then the solvent evaporation from the imprinted polymer gel through the PDMS mask is incomplete and thus the surface gel still exists giving rise to some interfacial polymer chain mobility. This enables solvent exchange between the two opposite surfaces, eventually leading to their bonding. The two bonded polystyrene pieces could not be manually separated, thus indicating an exceptionally strong and irreversible bond. The complete bonding and type ‘B’ imprinting process is illustrated with a representative example shown in FIG. 11A of a microfluidic channel that is 600 μm wide and 80 μm or even 100 μm deep. The inset shows a photograph of the same structure. In FIG. 11B, a smaller microchannel is illustrated, 25 μm wide and approximately 6 μm deep, ending in a 3 μm wide indentation. Bonding to heterogeneous surfaces was also possible, including both inorganic and organic substrates, such as poly(methyl methacrylate) (PMMA) with a similar exceptionally strong bond, as shown in FIG. 11C.

### Dopant Impregnation

Solutions, instead of pure solvents, enable the dopant solute transport into the polymer. As a result, the impregnated polymer becomes functionalized with the solute, which can be dissolved sensing or catalytic molecules. In addition, the now dopant-impregnated polymer can be readily imprinted and bonded. Such an example is illustrated in FIG. 11C involving a polystyrene microchannel imprinted using an acetone solution of a chromophore, as described above, bonded to a thin PMMA film and filled with a fluorescent ethanol solution. The image of FIG. 11C is a 3D reconstructed fluorescence confocal one, illustrating the chromophore implantation in all imprinted surfaces, including the sidewalls and bottom surface of the microchannel. This type of dopant molecule distribution increases the overlap between the chromophore and the channel's contents, and hence enhances their interaction. This is an attractive feature for both sensing and flow-through catalysis.

### Microstructured Oxygen Sensors

The description above of polymer-solvent interactions, specifically in relation to dopant-impregnation and deep feature imprinting, can be applied to prototyping oxygen sensing optofluidics—microsystems that have recently attracted substantial attention—as oxygen is one of the most important electron acceptors in biology and chemistry. However, contrary to previous reports of optical sensor integration with microfluidics, the present invention enables controlled 3D distribution of the sensing dopant molecules. This, as already discussed, enables higher overlap between the sensor and analyte and thus offers the possibility of more informative sensing. Another consequence is the similarity between the sensing layer and the imprinting depths, ‘dₛ’ and ‘dₚ’, respectively in FIG. 12A, which is a schematic diagram a microfluidic sensor wherein the sensitized layer contains a microchannel capped by a cover plate. This minimizes reagent consumption, but also decreases the background noise by selectively positioning the sensing molecules in close proximity to the imprinted features, i.e. dₛ˜dₚ. Contrary, in the dₛ>dₚ case, not all molecules would efficiently interact with O₂ and their unmodified lifetime ‘τᵢ’ would negatively contribute to the background noise, as illustrated in FIG. 12A, which illustrates sensor distribution and one example geometry for optical excitation and collection. The excitation is illustrated by the bottom arrows, I_{exc} and the collection by the upper arrows. For oxygen sensing, the collection signal ‘I_{signal}’ depends on the excited state lifetimes of all chromophores embedded within the sensitized layer in the path of the optical excitation.

For the sensor formation, polystyrene films were impregnated for 1 second in a chloroform solution of the oxygen sensitive dye Pt(II) meso Tetra(pentafluorophenyl) porphine, leading to the 3D integration of the sensing molecule, as shown in FIG. 12B. FIG. 12B is a confocal image of a bonded polystyrene microchannel formed impregnation in a fluorescent chloroform solution with an approximate depth of 50 μm. The lower image shows the cross-sectional fluorescence intensity distribution across the channel. The imprinted microchannel was bonded to a polystyrene film containing a single inlet, and kept overnight in a nitrogen atmosphere. Oxygen was detected by reduction of the phosphorescence lifetime of the implanted sensing molecule. For this, the microchannel was sealed under strict nitrogen condition and was then positioned in a Fluorescence Lifetime Imaging (FLIM) setup. Subsequently, access of ambient gaseous O₂ (approximately 12%) to the microchannel was allowed.

A series of FLIM snapshots following the transport of gaseous oxygen diffusion in the microchannel of FIG. 12A is shown in FIG. 12C. Both the microchannel bottom surface (area ‘1’) and its walls (areas ‘2a’ and ‘2b’) were oxygen sensitive upon gas entry (t=0.5 minutes). However, the bottom surface of the channel (1′) exhibited faster response kinetics than the channel walls (2′), as better visualized in the contour graph of FIG. 12D that traces the lifetime as a function of time and distance across the microchannel (as described in detail in the previous EXAMPLE 1). The response kinetics difference is due to the different O₂ diffusional barriers, with the fastest response occurring closest to O₂ that necessitates shorter diffusion times. The influx of oxygen reduces the fluorescent lifetime, which then appears darker, showing the sensing of oxygen by the dye impregnated in the plastic. Based on the spatiotemporal analysis of the results shown in FIG. 12D, the oxygen diffusion coefficient in polystyrene was estimated to be 4*10⁻⁸ cm²/sec. FIG. 12D is a contour plot of the phosphorescence lifetime in response to oxygen as a function of time (x-axis) and distance (y-axis corresponds to the white line shown in FIG. 12B and the upper left image of FIG. 12C). The influx of oxygen reduces the fluorescent lifetime, which then appears darker, showing the sensing of oxygen by the dye impregnated in the plastic.

### Cell Growth Microbioreactors

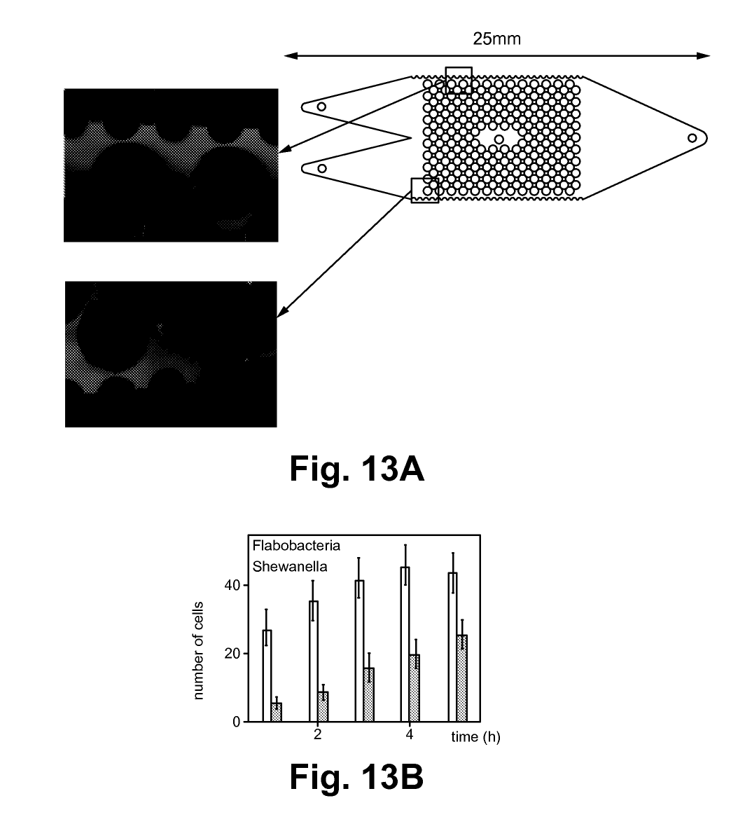

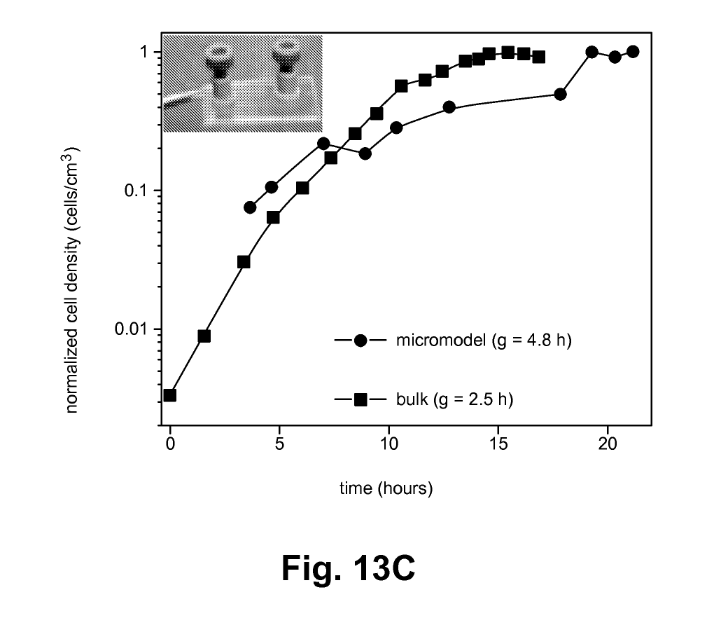

Polymer microreactors were fabricated for microbial growth studies in confined environments. Pore network microfluidic structures (or ‘micromodels’) were chosen, similar to the ones shown in FIG. 13A. This class of microfluidics was employed due to its relevance in quantifying transport in porous media and is representative of ecological heterogeneous subsurface environments. The micromodels were fabricated by immersing the polystyrene substrates in acetone and were subsequently imprinted with an approximately 5 μm deep PDMS stamp. The imprinted printed surface was bonded to a 250 μm thick polystyrene film containing access ports assembled with Nanoport fittings. Micromodels with homogenous pore networks were employed and microbial cell cultures were introduced, grown and imaged. A typical image of a mixed microbial culture is shown in FIG. 13B for Shewanella and Flavobacteria expressing different fluorescent proteins. It was possible to determine the cell doubling time by counting the number of cells as a function of time at fixed, 174×130 μm square regions across the microchannel depth, as shown in the inset of FIG. 13B. These results show that complex 3D structures can be created, and they can be used as cell bioreactors.

The polystyrene micromodels were employed to investigate the growth of Clostridium Thermocellum. This strain requires strict anaerobic conditions and an optimal temperature of 60° C. for growth. Such conditions are challenging for elastomeric materials, such as the typically used PDMS, because of oxygen permeability of PDMS and buffer evaporation through the permeable PDMS. C. Thermocellum cells were loaded in a polystyrene micromodel in a nitrogen atmosphere. Subsequently, the micromodels were sealed at their Nanoport fittings, as shown in the inset of FIG. 13C and transported to a 60° C. incubator. Cell growth was observed for over 20 h by counting cells at four different micromodel locations that exhibit less than 10% standard deviation between them. The cell-doubling time for C. Thermocellum in the micromodel was approximately 4.8 h, considerably longer than the corresponding value of 2.5 h measured in batch media, as shown in the growth curves of the C. Thermocellum in FIG. 13C for cells grown in polystyrene micro-scale pore models (blue) and under ideal culture conditions (red). This is attributed to the availability of key nutrients in a well-mixed batch system, where waste products are rapidly removed from around the cells and growth substrates are in excess. These conditions contrast with those within a micromodel. In the latter, minimal mixing around the biomass is more likely to occur, and localized chemical gradients develop through the generation of waste products and utilization of growth substrates around regions of microbial growth. Additionally, differences in the micromodel growth environment may lead to shifts in the metabolism and physiology of the microbial population, further contributing to the observed slower doubling time. However, it is worth noting that growth in the polystyrene micromodels is more representative of heterogeneous subsurface conditions, where the majority of biomass is attached to soil and mineral particles and is therefore exposed to limited pore water mixing. This illustrates that microfluidic devices and sensors, according to embodiments described herein, can be used in cell culture.

### Example 3

### Impregnation of Polystyrene with Dye by Injection of the Dye Solution into a Plastic Structure

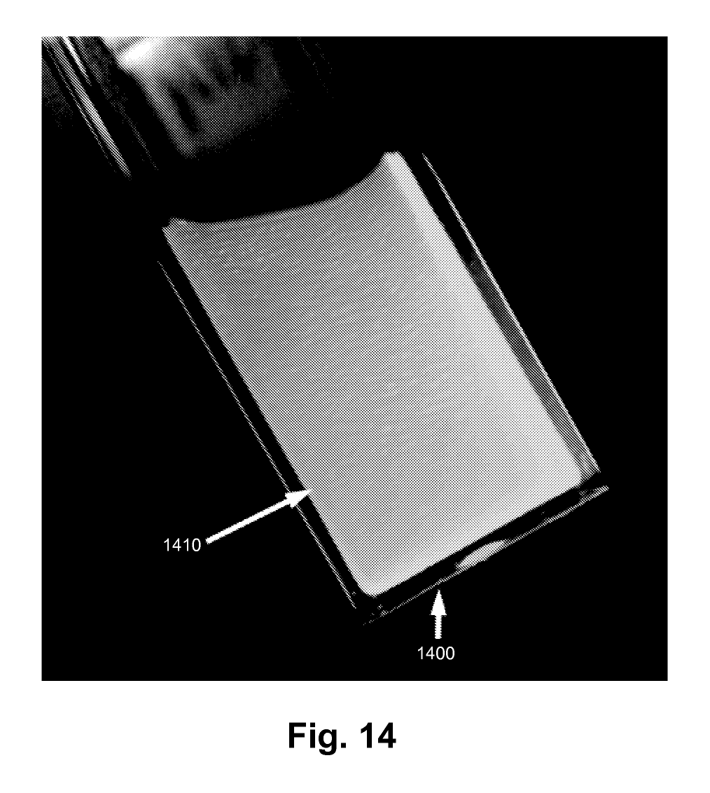

A solution of NPO dye in 2-butanone was injected by pipette into a 1 cm path length polystyrene cuvette. After 5 sec, the solution was withdrawn by the pipette and the plastic was allowed to try. Under UV illumination to excite the luminescence of the dye, as shown in FIG. 14, the luminescence of the impregnated plastic on the inside surfaces 1410 of the plastic cuvette 1400 that was contacted by the solution is clearly visible. A three dimensional structure containing dye has been created on a portion of the interior of the container. Additional experiments were conducted with 10 sec, 20 sec, and 40 second contact times. In each case, a portion of the inside surface of the plastic structure was impregnated with dye by the injected solution. One cuvette was fractured and a cuvette wall was imaged in cross section using visible and fluorescence microscopy, clearly showing a fluorescent region of discrete thickness in the plastic, corresponding to the PtTFPP dopant impregnated region at the inside surface of the cuvette. The bulk plastic of the cuvette walls and outside surfaces are not fluorescent.

### Example 4

### Creation of an Oxygen Sensor by Impregnation of Polystyrene with TFPP Dye by Injection of the Dye Solution into a Plastic Structure

A solution of PtTFPP dye in 2-butanone at 10 mg/g solution concentration was injected by pipette into a 1 cm path length polystyrene cuvette. After approximately 10 sec, the solution was withdrawn by pipette and the plastic was allowed to dry. Due to the time to inject and the time to withdraw solutions, the actual exposure time was greater than the nominal 10 seconds. A second cuvette was prepared according to the same method and parameters. In visible light the red colored dye was clearly apparent in the interior of the cuvette, and the two cuvettes were equivalent. A dye impregnated layer of polystyrene lines the interior surfaces of the cuvette where the solution contacted the interior of the cuvette.

PtTFPP dye in plastic substrates, such as polystyrene, is known to be an oxygen sensor. The luminescence and luminescent lifetime are both decreased in the presence of oxygen relative to anoxic conditions. Put more simply, the dye luminescence is brighter in the absence of oxygen.

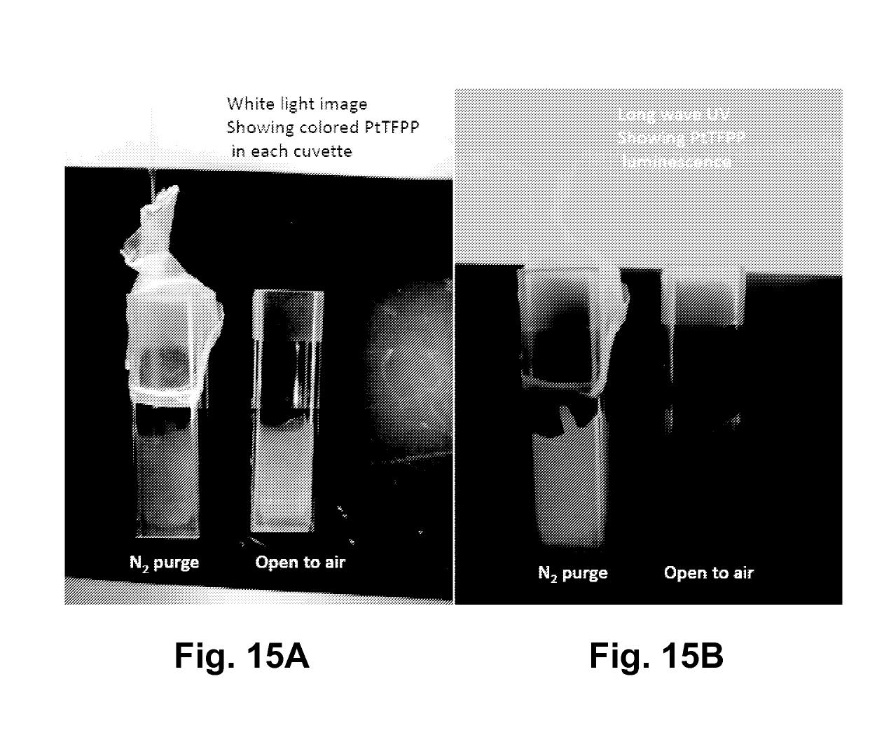

The two cuvettes, after drying, were placed side by side on a black laboratory bench, and a piece of tubing delivering pure nitrogen was inserted into one. The other cuvette was open to air. These two cuvettes, set up as described and in visible light, are shown in FIG. 15A. After purging one cuvette with nitrogen, in order to remove oxygen, the cuvettes were examined under ultraviolet excitation light. The luminescence of the sensing layer on the interior of the cuvette exposed to oxygen in the air was much less than the luminescence from the cuvette purged with nitrogen, as shown in FIG. 15B.

The nitrogen delivery tube was removed from the original cuvette and transferred to the cuvette that had been open to air. It was again observed that the luminescence from the cuvette exposed to oxygen in the air was much less than that of the cuvette being purged with nitrogen.

A cuvette was fractured and a cross sectional view was examined with the microscope. Under visible light, a discrete near surface region corresponding to the impregnated gel layer during fabrication, was observed as a dark band, due to light absorption by the red PtTFPP dye. Under UV light, the same band that had been dark under the visible was light in the UV due to the luminescent emission of the impregnated dye.

This example illustrates creation of an oxygen sensor by impregnating an oxygen sensing dye into a region of discrete thickness at the surface of plastic by contacting the interior surfaces of a plastic device with dye-containing solution for a fixed period of time, withdrawing the solution, and drying. Further, it illustrated creation of a sensor by injecting solution into a plastic device, as opposed to immersing a solid piece of plastic into a solution. Further, it demonstrates creation of a three dimensional sensing structure within a portion of a plastic container.

### Example 5

### PtTFPP Impregnated Disc

Polystyrene discs were cut by laser from rectangular polystyrene microscope slides. One disc was clamped in an apparatus such that liquid could be placed onto one side of the disc, whilst protecting the other side of the disc from contact with the liquid. One side of the disc was contacted with an acetone solution of the oxygen sensing PtTFPP dye for 20 seconds. The disc was allowed to complete drying.

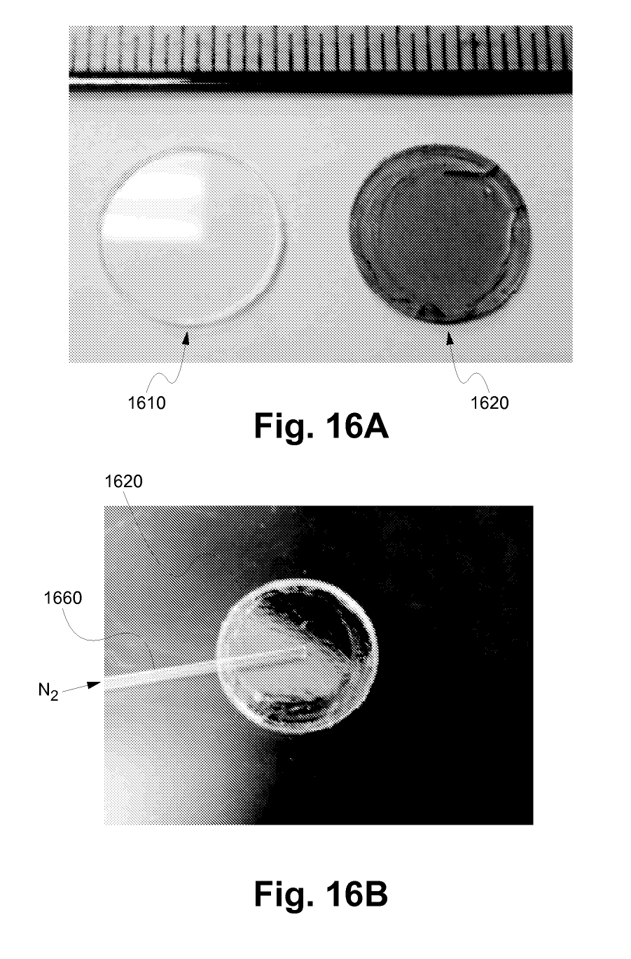

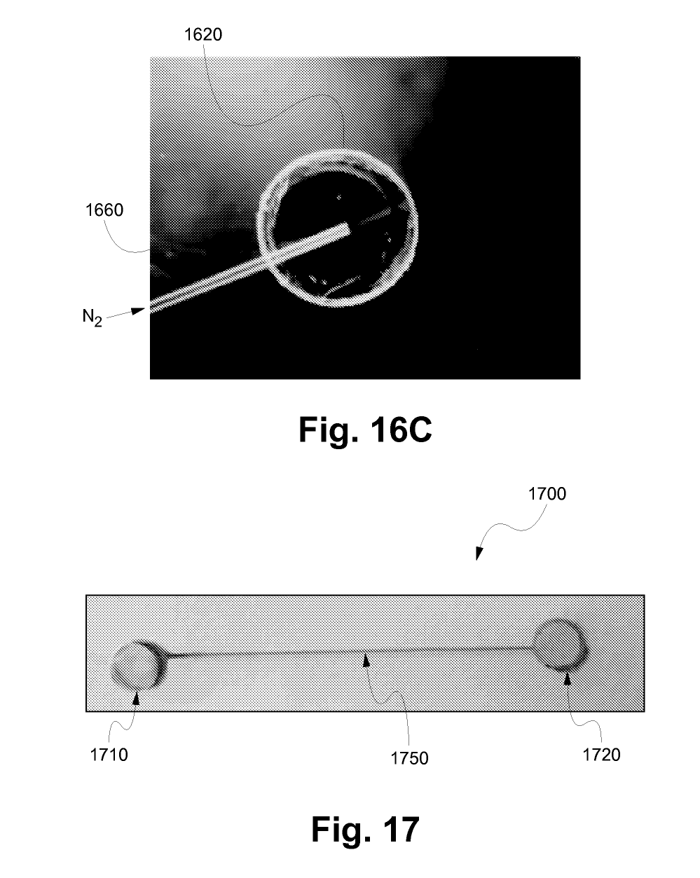

The disc was now colored red on one side by the red PtTFPP dye impregnated into the surface region of the polystyrene. A comparison of the blank disc 1610 and the dye impregnated disc 1620 is shown in FIG. 16A. The dye impregnated disc is clearly darker due to the red color of the impregnated dye.

The dye impregnated disc 1620 was positioned on a black surface with a tube 1660 delivering a flow of nitrogen gas at 500 mL/min across the disc from the center to one side. The disc 1620 was imaged under white light to show the experimental set up, as shown in the image of FIG. 16B, and under long wave UV light to excite the PtTFPP dye luminescence, as shown in the image of FIG. 16C. The luminescence of most of the disc, which is exposed to oxygen in the air, is much less than the bright line of luminescence seen under the nitrogen flow, in line with the tube 1660 delivering the nitrogen gas and protecting part of the surface from interaction with oxygen in the air.

This example demonstrates that just one side of a piece of plastic may be contacted with a dye containing solution, and it demonstrates that this structure having a dye impregnated into a discrete near surface region of the plastic, produced by this method using solvent to create a gel layer into which the dye diffuses, has oxygen sensing functionality. This type of disc may be affixed to the end of an optical probe as part of an oxygen sensing device or system.

### Example 6

### Impregnation of Dye into the Interior Walls of Plastic Microchannel Devices

A plastic microchannel device 1700, made of PMMA, was created, featuring a singlet inlet 1710 and a single outlet 1720 connected by a single straight microchannel 1750, as shown in FIG. 17.

A solution of PtTFPP in ethylbenzene was injected into the microchannel, and then displaced with air. The solution of the dye was in contact with the interior surfaces of the microchannel for approximately 30 minutes. The solvent was finally removed from the microchannel that was allowed to dry in air.

The microchannel is clearly colored by the impregnation of the dye into the walls of the channel. In addition, the fluorescence of the impregnated dye can be seen under long wave UV illumination.

This example illustrates the impregnation of dye into the interior walls of a plastic microchannel by injection of the solution into the microchannel in order to contact the plastic with the dye-containing solution.

In further demonstrations, a plastic microchannel device was prepared in polystyrene plastic. Like the microchannel device just described, it had a singlet inlet and a single outlet connected by a single straight microchannel. A solution of PtTFPP in ethylbenzene was injected into the microchannel, and then displaced with air, for a contact time of a few seconds. The channel was allowed to dry. Hence this microchannel contains the PtTFPP dye in polystyrene, which is a combination of dye and polymer with excellent oxygen sensing capability. The dye is located in a discrete surface region in the walls of the microchannel.

This polystyrene device was imaged using a fluorescence microscope. The microchannel was clearly visible with white light illumination. Changing to UV illumination, the microchannel and only the microchannel was seen to emit the luminescence of the PtTFPP dye, confirming that the dye impregnation was confined to the exposed surfaces inside the microchannel.

The device was broken apart and a fractured surface normal to the direction of the channel was examined with the microscope. Under visible illumination, the discrete region at the microchannel surface that had been impregnated was visible. With UV illumination, it was seen that this discrete region was fluorescent, and hence contained the PtTFPP oxygen sensing dye.

This example thus shows creation of an oxygen sensing structure in a microchannel by the solvent impregnation method. Further this example shows an oxygen sensing microfluidic structure where the fluidic channels and the sensing structure are colocated. Further, the sensing structure is three dimensional.

### Example 7

### Creation of a Scintillator by Impregnation of Polystyrene with Acetonitrile Solvents Containing NPO Dye

In this example, a dye and polymer serve as a scintillator. The thickness of a scintillator determines its selectivity for different types of radioactive particles or energy. A thin scintillator layer will be selective for alpha or weak beta particles emitted in close proximity to the surface whereas more energetic gamma rays or cosmic rays will go right through a thin scintillator layer with little likelihood of depositing energy in the dyed layer. Hence, the method described can produce a scintillator with low sensitivity to background radiation. Diffusion of scintillating fluorophore dyes such as, but not limited to, 2-(1-Naphthyl)-5-phenyloxazole (“alpha-NPO”) or PPO into polystyrene may serve as such a scintillator layer.

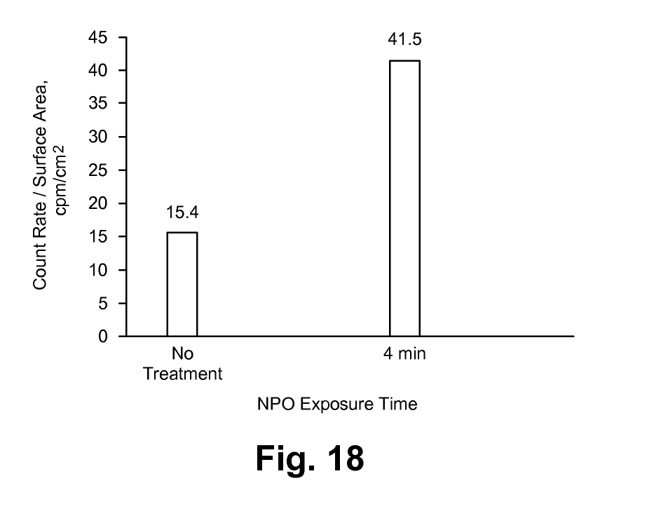

FIG. 18 shows the count rate response for a solid polystyrene polymer impregnated with NPO from a solution of NPO in acetonitrile solvents, compared to a non-treated polymer. Both samples were exposed to the beta emitting radionuclide ⁹⁹Tc in water. The signal from the dye-impregnated polymer is substantially higher than that of the non-treated polymer. This illustrates that the solid polymer impregnated by a solvent solution containing dye can be used as a scintillator or radiation sensor.

### CONCLUSIONS

By using solvents and creating a sensing layer, which may be three-dimensional, by impregnating a controlled depth of the bulk material with a dopant such as a dye, there is not a major interface between the surface sensing layer and the bulk material; they are all essentially one material. The sensing layer does not dewet the surface as a separate layer, or delaminate from the surface as a separate layer could.

From an optical point of view, the lack of an interface between disparate substrate and sensing materials removes a reflecting surface that can negatively affect the performance of a sensor that uses an optical readout of the dye in the surface film or surface region.

In addition, this method may impregnate, to controlled depths, the surfaces of polymer materials that may not be large and flat. A curved surface, or a surface with topographic features, or multiple surfaces on the outside of a polymer solid, or multiple surfaces of a void or channel inside a polymer device, may be impregnated with dopants to create sensing surfaces. Thus the sensing layer can be three-dimensional.

Sensing layer structures, created by these methods, can be used for point sensing, for chemical imaging across planer areas, or for sensing in three dimensional structures such as containers or microchannels.

In one application, oxygen sensors can be created by impregnating fluorescent oxygen sensing dyes into the surface region of the plastics. When an oxygen sensing dye is included in solution with the solvent that creates the gel layer, the polymer material becomes impregnated with dye to a discrete depth at the surface. This dyed layer, after drying, then serves as an oxygen sensor.

In another application, point sensors may be prepared in which the sensing head is formed by impregnating the sensing dye into the surface of a bulk disk, which is then affixed to the probe assembly. Or the sensing head may be formed by impregnating the end of a polymer cylinder or polymer fiber, where the cylinder or fiber also acts as a waveguide for interrogating the sensing region.

In another application, oxygen sensing microfluidic structures can be created. When an oxygen sensing dye is included in solution with the solvent that creates the gel layer, the polymer surface becomes impregnated with dye to a discrete depth. If the gel layer is imprinted before drying, a 3D sensor surface or microfluidic sensor can be created. Such devices are useful for oxygen sensing and imaging oxygen concentrations and gradients.

In another application, an enclosed microfluidic structure in a plastic such as polystyrene can be converted to an oxygen sensing microfluidic structure by contacting the interior surfaces with a solution of the oxygen sensing dye, and thus impregnating the interior surfaces to create a dye containing region of discrete depth at the interior surfaces of the microchannel. In this approach, the dye is only impregnated into the walls of the microfluidic channel, and thus dye luminescence is spatially co-located with fluidic microchannels. This structure differs from the application of the prior paragraph, where the dye will be present across an entire surface while microchannels are created in portions of the gel layer by imprinting and subsequently bonding on a cover plate.

In another application, a dye and polymer may serve as a scintillator. The thickness of a scintillator determines its selectivity for different types of radioactive particles or energy. A very thin scintillator layer will be selective for alpha or weak beta particles emitted in close proximity to the surface whereas more energetic gamma rays or cosmic rays will go right through a thin scintillator layer with little likelihood of depositing energy in the dyed layer. Hence, the method described can produce a scintillator with background rejection. Diffusion of “alpha-NPO” dye into polystyrene will serve as such a scintillator.

In one application, disposable bioreactors capable of observing biomass and sensing environmental conditions therein can be prepared. By imprinting, functionalizing and enclosing the surface, artificial environments can be synthesized for the control and sensing of cell-based systems such as cell bioreactors, tissue, culture, and fermentation.

In another application, plastic labware for growing and controlling cell-based systems, such as cell, tissue, or fermentation bioreactors, can be converted to oxygen sensing containers by impregnating an oxygen sensing dye into the interior surfaces of these labware containers. Thus the container for cell growth can, by this method, also sense the growth conditions as they relate to oxygen concentrations.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. A sensor comprising:
a. a solid polymer material; and
b. a dopant-containing region of discrete thickness at a surface of the solid polymer.

2. The sensor of claim 1 wherein the polymer material is one of the following:
polystyrene, polycarbonate, polyvinyltoluene, cyclic olefin copolymer, and polymethylmethacrylate, polyacrylic acid, polymethylmethacrylate, poly(ethylene terephthalate), polypropylene, polyethylene, polyvinylchloride, polyester, polyacetate, acrylonitrile butadiene styrene copolymer (ABS), TPE/TPU, nylon, silicone, polyphenylene ether (PPE), polyphthalamide (PPA), polyetherimide (PEI), polyethersulfone (PES), polyaromatic ether ketones (PAEKS), liquid crystal polymer (LCP), polyphenylene sulfide (PPS), or polysulfone (PSU).

3. The sensor of claim 1 wherein the dopants are sensitive to a chemical species.

4. The sensor of claim 1 wherein the dopants are fluorescent dye molecules.

5. The sensor of claim 4 wherein the chemical species is oxygen from a gas phase sample or oxygen dissolved in water or other liquid phase.

6. The sensor of claim 4 wherein the fluorescent dye molecules in the polymer create a scintillator to ionizing radiation.

7. The sensor of claim 1 wherein the sensor is a three dimensional structure.

8. The sensor of claim 7 wherein the three dimensional sensor is on inside surfaces of a three dimensional solid structure.

9. The sensor of claim 7 wherein the surface of the polymer includes an impression.

10. The sensor of claim 9 further comprising a top polymer plate, wherein the top plate bonds to the impressed polymer material, thus forming enclosed channels.

11. The sensor of claim 10 wherein the dopants are present within the solid polymer in the regions near side walls and bottom of the grooves or channels.

12. The sensor of claim 10 further comprising one or more pumps and valves to control fluid flow from one channel end to another.

13. The sensor of claim 9 wherein the grooves in the polymer are up to about 100 μm in depth.

14. A method of making a sensor comprising: contacting at least one surface of a three dimensional polymer material with a solvent solution containing dopants, wherein the dopants are diffused into the polymer material, forming a dopant-containing region of discrete thickness at a surface of the solid polymer.

15. The method of claim 14 wherein a polymer/solvent gel-layer, whose depth increases with impregnation time, forms after contact of the polymer material with the solvent solution.

16. The method of claim 15 wherein the dopants are substantially confined within the solid polymer to the region at the surface created by the polymer/solvent gel-layer.

17. The method of claim 16 wherein the dopants penetrate to a lesser depth within the solid polymer than the polymer/solvent gel-layer.

18. The method of claim 16 wherein the dopants penetrate to an approximately equal depth within the solid polymer as the polymer/solvent gel-layer.

19. The method of claim 16 wherein the dopants are sensitive to a chemical species.

20. The method of claim 19 wherein the chemical species is oxygen in the gas phase or oxygen dissolved in water.

21. The method of claim 14 wherein the dopants are fluorescent dye molecules.

22. The method of claim 21 wherein the fluorescent dye molecules in the polymer create a scintillator to ionizing radiation.

23. The method of claim 14 wherein the solvent is at least one of the following: chloroform, acetone, 2-butanone, tetrahydrofuran, acetonitrile, dichloromethane, ethanol, methanol, water, benzene, toluene, carbon tetrachloride, chloroform, diethyl ether, dimethylsulfoxide, dimethylformamide, formamide, n-propanol, isopropanol, n-butanol, ethylbenzene, xylene, mesitylene, pentane, hexane, heptane, petroleum ether, phenol, cyclohexanone, di-isopropyl ether, diethyl ether, or mixtures thereof.

24. The method of claim 14 wherein the polymer material is one of following: polystyrene, polycarbonate, polyvinyltoluene, cyclic olefin copolymer, and polymethylmethacrylate, polyacrylic acid, polymethylmethacrylate, poly(ethylene terephthalate), polypropylene, polyethylene, polyvinylchloride, polyester, polyacetate, acrylonitrile butadiene styrene copolymer (ABS), TPE/TPU, nylon, silicone, polyphenylene ether (PPE), polyphthalamide (PPA), polyetherimide (PEI), polyethersulfone (PES), polyaromatic ether ketones (PAEKS), liquid crystal polymer (LCP), polyphenylene sulfide (PPS), or polysulfone (PSU).

25. The method of claim 14 where one or more exterior surfaces of the three dimensional polymer solid are impregnated with the dopant.

26. The method of claim 14 where one or more interior surfaces of the three dimensional polymer structure are impregnated with dopant.

27. The method of claim 15 further comprising stamping the surface of the polymer/solvent gel-layer, creating impressions in the surface of the polymer/solvent gel-layer.

28. The method of claim 27 further comprising converting the impressions into channels by bonding a top polymer plate to the impregnated polymer material.

29. The method of claim 28 wherein the dopants are present within the solid polymer in the regions near side walls and bottom of the grooves or channels.

30. The method of claim 29 further comprising controlling fluid flow from one channel end to another using one or more pumps and valves.

31. A method of creating a microfluidic sensor comprising:
a. contacting a solid polymer material with a solvent solution containing dopant molecules, thus creating a polymer/solvent gel layer of discrete time-dependent thickness;
b. diffusing the dopant molecules into the gel layer of the polymer;
c. removing the polymer from the solvent solution;
d. imprinting a three dimensional structure in the dopant diffused gel layer; and bonding the imprinted layer to a top cover plate.
